(19) United States
(12) Patent Application Publication
(10) Pub. No.: US 2023/0271257 A1
(43) Pub. Date: Aug. 31, 2023

(54) METHOD FOR DETERMINING INDIVIDUAL VECTORS FOR OPEN-LOOP AND/OR CLOSED-LOOP CONTROL OF AT LEAST ONE ENERGY BEAM OF A LAYERING APPARATUS, AND LAYERING APPARATUS

(71) Applicant: MTU Aero Engines AG, München (DE)

(72) Inventors: Sebastian Rott, München (DE); Katrin Friedberger, Odelzhausen (DE); Alexander Ladewig, Bad Wiesse (DE); Christian Liebl, Bockhorn (DE); Steffen Schlothauer, Erdweg (DE); Johannes Casper, München (DE); Jonas Weich, Burgkunstadt (DE)

(73) Assignee: MTU Aero Engines AG, München (DE)

(21) Appl. No.: 18/007,272

(22) PCT Filed: Jul. 22, 2021
(86) PCT No.: PCT/DE2021/100637

§ 371 Date: Jan. 27, 2023

(30) Foreign Application Priority Data
Jul. 28, 2020 (DE) 10 2020 209 470.5

(51) Int. Cl. B22F 10/85; B22F 10/28; G05B 19/4099

(52) U.S. Cl. CPC B22F 10/85; B22F 10/28; G05B 19/4099; B33Y 50/02

(57) ABSTRACT

The invention relates to a method for determining individual vectors for open-loop and/or closed-loop control of at least one energy beam of a layering apparatus, comprising at least the steps of: providing layer data characterizing at least one component layer of a component to be additively manufactured, on the basis of the layer data, determining individual vectors, according to which at least one energy beam is to be moved relative to a construction and joining zone of the layering apparatus in order to solidify a material powder selectively to the component layer, determining at least one node point of a plurality of individual vectors, and adapting at least one property of at least one individual vector of the at least one node point, the at least one property being selected from a group comprising spatial orientation, radiation sequence in relation to at least one other individual vector, and vector length.

### BACKGROUND OF THE INVENTION

The invention relates to a method for determining individual vectors for open-loop and/or closed-loop control of at least one energy beam of a layering apparatus. The invention further relates to a layering apparatus for the additive manufacture of at least one component region of a component. The invention additionally relates to a computer program product and a computer-readable storage medium.

Additive layering methods refer to processes in which geometric data are determined on the basis of a virtual model of a component or component region that is to be manufactured. Depending on the geometry of the model, an exposure or irradiation strategy is determined, according to which the selective solidification of a material is to occur. In layering methods, the desired material is then deposited in powder form layer by layer and selectively scanned and solidified by at least one energy beam in order to additively construct the desired component region. Various irradiation parameters, such as, for example, the energy beam power and the exposure speed of an energy beam used for solidification, are of importance for the resulting microstructure. In addition, the arrangement of so-called scan lines is also of importance. The scan lines, which may also be referred to as fusion tracks or as exposure vectors, are defined by individual vectors along which the at least one energy beam scans and fuses the material. Accordingly, additive or generative manufacturing methods differ from conventional material-removing or casting manufacturing methods. Examples of additive manufacturing methods are additive laser sintering and laser fusion methods, which, for example, can be used for the manufacture of components for turbomachines, such as aircraft engines. In the case of selective laser fusion, thin powder layers of the material or of the materials used are applied to a construction platform and fused and solidified locally in the region of a construction and joining zone by using one or more laser beams. Subsequently, the construction platform is lowered and another powder layer is applied and again solidified locally. This cycle is repeated until the finished component or the finished component region is obtained. Subsequently, as need be, the component can be further processed or else can be used without further processing steps. In selective laser sintering, the component is produced in a similar way by laser-assisted sintering of powdered materials. The supply of energy hereby occurs, for example, by way of laser beams of a CO₂ laser, an Nd:YAG laser, a Yb fiber laser, a diode laser, or the like. Also known are electron beam methods, in which the material is scanned and solidified selectively by one or more electron beams.

The creation and preparation of models of the components that are to be produced occurs generally by a CAD program or the like. The geometric data thereby created are processed subsequently by a so-called slice process to obtain layer data, which are afterwards delivered to the layering apparatus. The processed data comprise essentially individual vectors (XY pairs and/or XY polylines), which are executed by the layering apparatus layer by layer and, among other things, serve for open-loop and/or closed-loop control of the energy beam.

On account of the data processing by CAD, the orientation of the individual vectors does not follow any ordered structure. At node points of thin-walled structures in which three or more individual vectors intersect or overlap, it often happens that more material than actually needed is bound, as a result of which these node points are more massive than the remaining component structure (thickening). However, when thin-walled structures, in particular, such as honeycomb seals, are produced, thickenings of this kind are undesirable and lead to non-uniform mechanical properties.

The problem of the present invention is to make possible an improved production of thin-walled components or component regions with more uniform mechanical properties. Further problems of the invention consist in specifying a computer program product and a computer-readable storage medium that make possible a correspondingly improved open-loop and/or closed-loop control of a layering apparatus.

### SUMMARY OF THE INVENTION

The problems are solved in accordance with the invention by a method, by a layering apparatus, by a computer program product, and by a computer-readable storage medium as set forth below. Advantageous embodiments with expedient further developments of the invention are also discussed below, with advantageous embodiments of each aspect of the invention being regarded as advantageous embodiments of each of the other aspects of the invention.

A first aspect of the invention relates to a method for determining individual vectors for open-loop and/or closed-loop control of at least one energy beam of a layering apparatus. The method according to the invention comprises at least the steps of a) providing layer data characterizing at least one component layer of a component to be additively manufactured, b), on the basis of the layer data, determining individual vectors according to which at least one energy beam is to be moved relative to a construction and joining zone of the layering apparatus in order to solidify a material powder selectively to the component layer, c) determining at least one node point of a plurality of individual vectors, and d) adapting at least one property of at least one individual vector of the at least one node point, the at least one property being selected from a group comprising the spatial orientation, the radiation sequence in relation to at least one other individual vector, and the vector length. In other words, it is provided in accordance with the invention that at least one property of at least one individual vector, which, together with at least two other individual vectors, forms a node point, is altered, whereby the property can involve the spatial orientation - that is, the start coordinates and end coordinates of the individual vector can be transposed (the vector A->B is transformed to its opposite vector B->A). Accordingly, the orientation can be selected for each individual vector in such a way that the resulting surface roughness due to caked powder particles of the thin-walled structure is influenced advantageously. This surface roughness is greater during out-coupling (end coordinates) than during in-coupling (start coordinates), so that, for example, when thin-walled structures are connected to a support, the out-coupled side should end in the support. The same holds for the binding of thin-walled structures to other, more massive component structures. Alternatively or additionally, what can be involved is the radiation sequence in relation to at least one other individual vector (“first vector A, then vector B” is reversed to “first vector B, then vector A”), the vector length (the individual vector is lengthened or shortened), or any combination thereof. In this way, a thickening in the node point is prevented or at least strongly diminished, as a result of which it is possible, in particular, to produce thin-walled component structures appreciably more exactly and with more uniform mechanical properties. In general, in the scope of this disclosure, “a/an” are to be read as indefinite articles, that is, unless stated explicitly otherwise, always as “at least one.” Conversely, “a/an” may also be understood to mean “only one.”

Preferably, it is provided that individual vectors that are present as a polygonal chain are split up into individual vectors prior to step d) and/or that at least two individual vectors that are present as individual vectors are combined into an open or closed polygonal chain after step d). A polygonal chain, which may also be referred to as a “polyline,” is understood to mean a continuous line consisting of a plurality of individual vectors that form line segments. In this way, it is possible to reduce in-coupling and out-coupling points of the energy beam, thereby likewise improving the production of thin-walled structures. In addition, a polyline can be treated advantageously as a single data object.

Further advantages ensue in that an irradiation sequence of at least two individual vectors is adjusted to be opposite to a predetermined flow direction of a protective gas flow of the layering apparatus. By arranging the irradiation or exposure sequence opposite to the flow direction, it is possible advantageously to prevent any detrimental influence by process byproducts, thereby leading to a higher component quality and a lower post-processing cost.

In an advantageous embodiment of the invention, it is provided that at least one node point is a split node point or a fusion node point. A split node point is understood to mean a node point in which an individual vector branches into two or more individual vectors, whereas a fusion node point is understood to mean a node point in which two or more individual vectors intersect and form the start point of a single individual vector. By the adaptation of the vectors or of the individual vectors in accordance with the invention, it is possible in the case of both node point variants to prevent in a reliable manner the creation of thickenings in the region of the point where the single individual vectors intersect.

Preferably, it is provided that at least one node point is resolved by changing the vector length of at least one individual vector. In other words, it is provided that the length of at least one individual vector is altered in such a way that, in the node point, it no longer intersects other individual vectors of the node point or its start point and end point no longer adjoin directly the start points or end points of other individual vectors, but rather are spaced apart from them. This represents a simple possibility for preventing thickenings in the node point. At node points, in-coupling and out-coupling points of the energy beam overlap, as a result of which a thickening of the material ensues. Through the resolution of the node points by alteration in the vector length, the multiple exposure is adapted in such a way that a binding of the individual tracks takes place without binding flaws or thickenings. This is advantageous particularly in the case of sealing elements with an inlet region and similar components, because the inlet area is smaller. In addition, it can be provided that the node point is further divided into branches. Depending on the category of the branch (split or fusion), it is possible to adjust the change in the vector length differently.

Further advantages ensue in that the irradiation sequence of a plurality of individual vectors is sorted in a construction direction and/or in that the spatial orientation of a plurality of individual vectors is adjusted in the same direction. In this way, it is possible to achieve an ordered irradiation involving a minimum number of changes in the direction of the energy beam. Besides an acceleration of the manufacturing method, also an improved microstructure and a lower interaction with process byproducts are thereby ensured.

In an advantageous embodiment of the invention, it is provided that the irradiation sequence of a plurality of individual vectors is sorted and/or oriented in such a way that the number of hops of the energy beam for the component layer is minimized. By way of such a minimization of the in-couplings and out-couplings, it is likewise possible to ensure an improved microstructure and a smaller interaction with process byproducts.

Preferably, it is provided that the adapted individual vectors are transmitted to a control device of the layering apparatus and are used for open-loop and/or closed-loop control of the at least one energy beam of the layering apparatus in order to additively manufacture at least one component layer. In other words, it is provided that the individual vectors that have been adapted in accordance with the invention are transmitted to a control device of the layering apparatus, if need be together with further data, and, in the scope of a layering method, are used for optimized manufacture of one component or of a plurality of components and, in particular, of thin-walled components of a turbomachine, such as, for example, a sealing element having a honeycomb structure. It can thereby fundamentally be provided that the control device itself carries out the adaptation of the individual vectors in accordance with the invention. Preferably, the component is designed as a honeycomb structure for a honeycomb seal. Such a honeycomb structure can be used alone or in combination with a seal carrier for sealing in turbomachines, such as gas turbines or aircraft engines.

A second aspect of the invention relates to a layering apparatus for the additive manufacture of at least one component by an additive layering method. The layering apparatus comprises at least one powder feed for applying at least one powder layer of a material onto at least one construction and joining zone of at least one movable construction platform, at least one beam source for generating at least one energy beam for layer-by-layer and local solidification of the material by selective scanning and fusion of the material along scan lines, and a control device. The control device is designed to control the powder feed in such a way that it applies at least one powder layer of the material onto the construction and joining zone of the construction platform and to control the construction platform in such a way that it is lowered layer by layer by a predefined layer thickness. It is provided in accordance with the invention that the control device is set up to use adapted individual vectors, which are determined by a method in accordance with the first aspect of the invention, for open-loop and/or closed-loop control of the at least one energy beam in order to additively manufacture at least one component layer. In this way, it is possible, in particular, to produce thin-walled component structures appreciably better and more precisely, because hitherto occurring thickenings at node points can be prevented. Further advantages ensue from the description of the first aspect of the invention.

Preferably, it is provided that the control device is set up to carry out a method in accordance with the first aspect of the invention. In this way, the control device is not dependent on the transmission of individual vectors that have already been adapted in accordance with the invention, bur rather can undertake the corresponding optimizations itself. In this way, it is possible also to optimize already existing or not yet optimized data sets subsequently in the intendment of the invention.

Preferably, it is provided that the apparatus is designed as a selective laser sintering apparatus or laser fusion apparatus. In this way, it is possible to produce component regions and entire components, the mechanical properties of which are at least essentially independent of direction. For the generation of a laser beam as the energy beam, it is possible to provide, for example, a CO₂ laser, a Nd:YAG laser, a Yb fiber laser, a diode laser, or the like. It is likewise possible to provide that two or more electron beams and/or laser beams are used as respective energy beams.

A further aspect of the invention relates to a computer program product, comprising commands that, when the computer program product is executed by a computing device, cause it to implement the method according to the first aspect of the invention. A further aspect of the invention relates to a computer-readable storage medium, comprising commands that, when executed by a computing device, cause it to implement the method according to the first aspect of the invention. The computing device can be an independent device that can be coupled to the control device of a layering apparatus for exchange of data. Alternatively or additionally, the computing device can be part of the control device of the layering apparatus. It is also possible to provide for an implementation of the method according to the invention that is divided up over a plurality of computing devices.

The present invention can be realized by use of a computer program product comprising program modules that are accessible from a computer-usable or computer-readable medium, and store program code that is used by or in conjunction with a computer, processor, or command execution system or by a plurality of computers, processors, or command execution systems of a layering apparatus. For the purposes of this description, a computer-usable or computer-readable medium can be any apparatus that can contain, store, communicate, propagate, or transport the computer program product for use by or in conjunction with the command execution system of the layering apparatus. The medium can be an electronic, magnetic, optical, electromagnetic, infrared, or semiconductor system or a propagation medium as such, because the signal carriers are not included in the definition of the physical, computer-readable medium. Included here is a semiconductor or solid-state memory storage, magnetic tape, an exchangeable computer diskette, a random access memory (RAM), a read-only memory (ROM), a magnetic hard disk, and an optical disk, such as a read-only memory (CD-ROM, DVD, Blue-Ray, etc.), or a writable optical disk (CD-R, DVD-R). Both processors and program code for implementation of the individual aspects of the invention can be centralized or divided up (or a combination thereof).

### BRIEF DESCRIPTON OF THE DRAWING FIGURES

Further features of the invention ensue from the claims, the figures, and the description of the figures. The features and combination of features mentioned above in the description as well as the features and combinations of features mentioned below in the descriptions of the figures and/or solely in the figures can be used not only in the respectively specified combination, but also in other combinations, without leaving the scope of the invention. Accordingly, embodiments of the invention that are not explicitly shown and explained in the figures, but which are derived and can be produced from the explained embodiments by separate combination of features, are also to be regarded as comprised and disclosed. Also to be regarded as disclosed are embodiments and combinations of features that thus do not have all features of a claim as originally formulated. Beyond this, embodiments and combinations of features, in particular through the embodiments presented above, that go beyond the combinations of features presented in the back references to the claims or deviate from them are to be regarded as disclosed. Herein:

FIG. 1 shows a schematic sectional view of a layering apparatus;

FIG. 2 shows a schematic diagram of a plurality of non-sorted and non-oriented individual vectors;

FIG. 3 shows a schematic diagram of a plurality of oriented individual vectors;

FIG. 4 shows a schematic diagram of a plurality of sorted and oriented individual vectors;

FIG. 5 shows a schematic diagram of a broadened split node point;

FIG. 6 shows a schematic diagram of a broadened fusion node point;

FIG. 7 shows a schematic diagram of a split node point in accordance with the invention; and

FIG. 8 shows a schematic diagram of a fusion node point in accordance with the invention.

### DESCRIPTION OF THE INVENTION

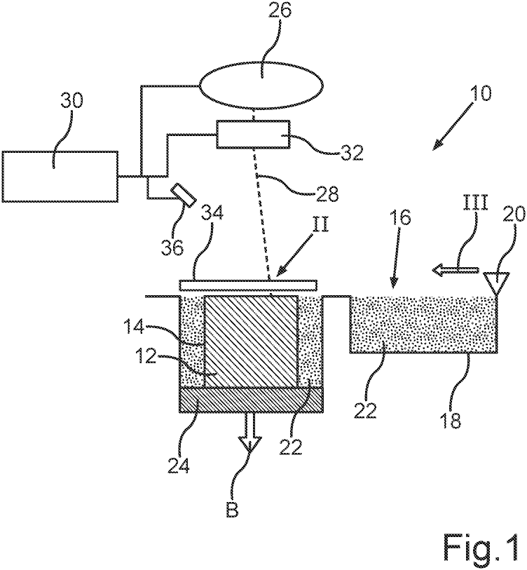

FIG. 1 shows a schematic sectional view of a layering apparatus 10. The layering apparatus 10 serves for additive manufacture of a component 14 by an additive layering method. The layering apparatus 10 comprises at least one powder feed 16 with a powder hopper 18 and a coater 20. The powder feed 16 serves for application of at least one powder layer of a material 22 onto a construction and joining zone II of a construction platform 24 that can move in accordance with arrow B. To this end, the coater 20 is moved in accordance with arrow III in order to transport material 22 from the powder hopper 18 to the construction and joining zone II. The layering apparatus 10 further comprises at least one beam source 26 for generating at least one energy beam 28 in the form of a laser beam, for example, for layer-by-layer and local solidification of the material 22, in that the material 22 is scanned selectively by the energy beam 28 along scan lines and is fused. In addition, a control device 30 is provided, which is designed to control the powder feed 16 in such a way that it applies at least one powder layer of the material 22 onto the construction and joining zone II of the construction platform 24 and the construction platform 24 is lowered layer by layer by a predefined layer thickness in accordance with arrow B. The layering apparatus 10 further comprises a fundamentally optional optical device 32, by which the energy beam 28 can be moved over the construction and joining zone II. The beam source 26 and the device 32 are coupled to the control device 30 for exchange of data. The layering apparatus 10 further comprises a likewise fundamentally optional heating device 34, by which the powder bed can be heated to a desired base temperature. The heating device 34 can comprise, for example, a fixed or movable induction coil or a plurality of fixed or movable induction coils. Alternatively or additionally, it is also possible to provide other heating elements, such as, for example, IR radiators or the like.

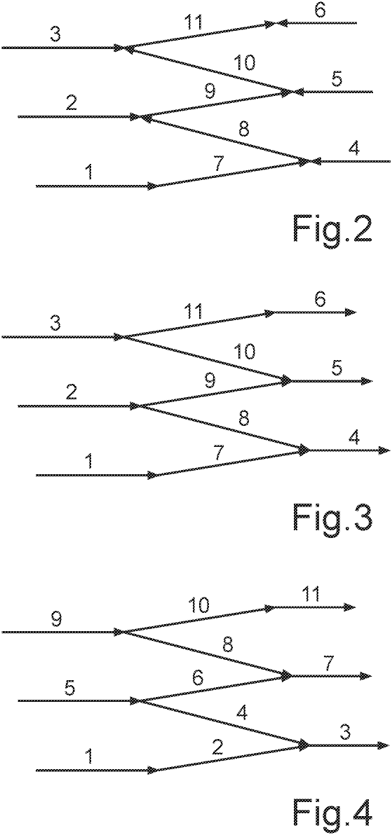

In accordance with the invention, the control device 30 is set up to actuate the beam source 26 and thereby to move the energy beam 28 along the scan lines during selective scanning. The scan lines are defined at the data level by individual vectors, such as are depicted with arrows in FIG. 2 to FIG. 8. The tip of the arrow marks the end coordinates of the individual vector in question, whereas the opposite-lying end of the individual vector marks the start coordinates.

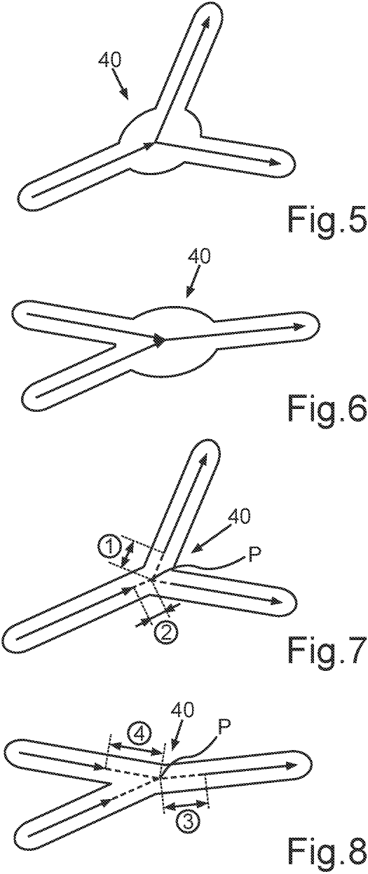

By additive methods, it is possible to construct the component 14 layer by layer. The method of laser powder bed fusion (LPBF) finds application especially in the sectors of the gas turbine and aircraft engine industry and is already being used in serial production for mounts and sealing elements. The production of thin-walled structures (for example, honeycomb structures) is often realized by use of an intrinsic set of parameters. The preparation of geometric data or the preparation of the component model is generally carried out by way of a CAD program. Subsequently, the prepared geometric data are broken down into layer data by way of a so-called slice process and the layer data is then transmitted to the layering apparatus 10 or to the control device 30. The processed data set essentially consists of individual vectors (XY pairs and/or XY polylines or polygonal chains), which are processed by the layering apparatus 10 layer by layer in order to construct the respective component. On account of the data preparation in CAD, the orientation of the vectors and polylines follows no ordered structure at the present time. In addition, the exposure sequence of the vectors is not sorted, thereby leading to undesired interactions with process byproducts. Ensuing from the continuous exposure of each individual vector is, moreover, a multiple exposure at node points 40. The consequence thereof is that more material than desired is fused and bound there and these node points 40 are more massive that the remaining structure. This is depicted in FIG. 5 and FIG. 6. Here, FIG. 5 shows a schematic diagram of a broadened split node point 40, while FIG. 6 shows a schematic diagram of a broadened fusion node point 40. A split node point 40 is understood to mean a node point 40 for which an individual vector branches into two or more individual vectors, whereas a fusion node point 40 is understood to mean a node point 40 for which two or more individual vectors intersect, so that their end points lie on the start point of a single individual vector.

By way of a digital processing of the layer data, it is possible, as needed, to resolve and correct the mentioned problems. To this end, there exist various measures that can be carried out individually or in any combination by a computing device (not shown) or by the control device 30 of the layering apparatus 10:

(a) XY polylines that are present are divided again into individual vectors, so that the exposure sequence and orientation can be adapted in a targeted manner.

(b) The exposure orientation of the individual vectors (start coordinates to end coordinates) can be selected for each individual vector in such a way that the resulting surface roughness of the produced thin-walled structure is positively influenced. The surface roughness is influenced, first of all, by caked powder particles. The surface roughness is generally greater during out-coupling (end coordinates of an individual vector) than during in-coupling (start coordinates of an individual vector), so that, for example, during the connection of thin-walled structures to form a thick-walled structure, the out-coupled side should end at the thick-walled structure. To this end, the start coordinates and end coordinates of the individual vector in question can be transposed.

(c) The exposure sequence is arranged opposite to the flow direction of a protective gas flow of the layering apparatus 10 in order to suppress any influence by process byproducts. In this way, too, it is possible, in particular, to produce thin-walled structures more precisely and freer of disruptions. FIG. 2 shows, for purpose of clarification, a schematic diagram of a plurality of non-sorted and non-oriented individual vectors, while FIG. 3 shows a schematic diagram of a plurality of individual vectors oriented from left to right in the figure and FIG. 4 shows a schematic diagram of a plurality of individual vectors sorted from bottom to top and oriented from left to right in the figure.

(d) It is possible, as needed, to combine the individual vectors at certain places or completely once again to form a polyline or a plurality of polylines, under the condition that an adapted exposure sequence and orientation is not altered. In this way, in-coupling and out-coupling points of the energy beam 28 can be reduced advantageously.

(e) Finally, it is possible by adapting the vector length of specific individual vectors to resolve node points 40 on the data level. At node points 40, in-coupling and out-coupling points of the energy beam 28 overlap, as a result of which, in practice, a thickening of the material results (FIG. 5, FIG. 6). By way of the mathematical resolution of the node point 40, the multiple exposure is adapted in such a way that, in practice, a node point 40 is formed, but that a connection of the individual vectors takes place without connection flaws. This is advantageous particularly in the case of sealing elements with an inlet region, because the inlet area is smaller. For example, it is thereby possible to reduce any spalling of fin coatings during run-in of a rotating blade of a turbomachine. To this end, FIG. 7 shows a schematic diagram of a split node point 40 according to the invention, while FIG. 8 depicts a schematic diagram of a fusion node point 40 according to the invention. It can be seen that, owing to the shortening of the individual vectors, the respective melt baths combine in the node point 40 without creating any thickening, as a result of which a precise and thickening-free thin-walled structure is produced. The node points can be subdivided here into branch types. Depending on the category of the branch (split or fusion), it is possible to select or to adjust differently the change in the vector length of specific individual vectors at a node point 40. For example, in FIG. 7, the vector length of the V-shaped branched individual vectors, starting form the center point P of the node point 40, is more strongly shortened than is the vector length of the single individual vector (amount (1) greater than amount (2)), because the melt baths of the two branched individual vectors overlap each other more strongly than they overlap the melt bath of the other individual vector. Analogously, in FIG. 8, the vector lengths of the V-shaped branched individual vectors are more strongly shortened with respect to the center point P than is the vector length of the other individual vector (amount (4) greater than amount (3)).

The parameter values given in the documentation for the definition of process and measurement conditions for the characterization of specific properties of the subject of the invention are also to be regarded in the scope of deviations - such as, for example, due to measurement errors, system errors, weighing errors, DIN tolerances, and the like -as being included in the scope of the invention.

What is claimed is:

1. A method for determining individual vectors for open-loop and/or closed-loop control of at least one energy beam of a layering apparatus, comprising at least the following steps:
a) providing layer data characterizing at least one component layer of a component to be additively manufactured;
b) on the basis of the layer data, determining individual vectors, according to which an energy beam is to be moved relative to a construction and joining zone of the layering apparatus to solidify a material powder selectively to the component layer;
c) determining at least one node point of a plurality of individual vectors; and
d) adapting at least one property of at least one individual vector of the at least one node point, the at least one property being selected from a group comprising spatial orientation, radiation sequence in relation to at least one other individual vector, and the vector length.

2. The method according to claim 1, wherein individual vectors that are present as a polygonal chain are divided prior to step d) into individual vectors and/or wherein at least two individual vectors that are present as individual vectors are combined after step d) to form an open or closed polygonal chain.

3. The method according to claim 1, that wherein an irradiation sequence of at least two individual vectors is adjusted opposite to a predetermined flow direction of a protective gas flow of the layering apparatus.

4. The method according to claim 1, wherein at least one node point is a split node point or a fusion node point.

5. The method according to that claim 1, wherein at least one node point is resolved by altering the vector length of at least one individual vector.

6. The method according to claim 1, wherein the irradiation sequence of a plurality of individual vectors is sorted in a construction direction and/or in that the spatial orientation of a plurality of individual vectors is adjusted in the same direction.

7. The method according to claim 1, wherein the irradiation sequence of a plurality of individual vectors is sorted and/or oriented so that a number of hops of the energy beam is minimized for the component layer.

8. The method according to claim 1, wherein the adapted individual vectors are transmitted to a control device of the layering apparatus and are used for open-loop and/or closed-loop control of the at least one energy beam of the layering apparatus to additively manufacture at least one component layer.

9. A layering apparatus for the additive manufacture of at least one component region of a component by an additive layering method, comprising:
at least one powder feed for applying at least one powder layer of a material onto at least one construction and joining zone of at least one movable construction platform;
at least one beam source for generating at least one energy beam for the layer-by-layer and local solidification of the material by selective scanning and fusing of the material along scan lines; and
a control device, which is configured and arranged:
to control the powder feed in such a way that it applies at least one powder layer of the material onto the construction and joining zone of the construction platform; and
to control the construction platform so that it is lowered layer by layer by a predefined layer thickness,
wherein the control device is configured and arranged to use adapted individual vectors, which are determined by a method according to claim 1, for open-loop and/or closed-loop control of the at least one energy beam to additively manufacture at least one component layer.

10. The layering apparatus according to claim 9, wherein the control device is configured and arranged to carry out the steps of:
a) providing layer data characterizing at least one component layer of a component to be additively manufactured;
b) on the basis of the layer data, determining individual vectors, according to which an energy beam is to be moved relative to a construction and joining zone of the layering apparatus to solidify a material powder selectively to the component layer:
c) determining at least one node point of a plurality of individual vectors, and
d) adapting at least one property of at least one individual vector of the at least one node point, the at least one property being selected from a group comprising spatial orientation, radiation sequence in relation to at least one other individual vector, and the vector length.

11. The layering apparatus according to claim 9, wherein it is configured and arranged as a selective laser sintering or fusion apparatus.

12. A computer program product, comprising commands that, when the computer program product is executed by a computing device, cause it to implement the method according to claim 1.

13. A computer-readable storage medium, comprising commands that, when executed by a computing device, cause it to implement the method according to claim 1.
